(19) United States
(12) Patent Application Publication
(10) Pub. No.: US 2013/0002577 A1
(43) Pub. Date: Jan. 3, 2013

(54) ADAPTIVE USER INTERFACE

(75) Inventor: Seung Il Kim, Seoul (KR)

(73) Assignee: Empire Technology Development LLC, Wilmington, DE (US)

(21) Appl. No.: 13/502,481

(22) PCT Filed: Jul. 1, 2011
(86) PCT No.: PCT/KR11/04857

§ 371 Date: Apr. 17, 2012

(51) Int. Cl. G06F 3/01; G06F 3/041

(52) U.S. Cl. 345/173; 345/156

(57) ABSTRACT

Technologies are generally described for providing an adaptive user interface. In some examples, a gesture-based apparatus may include a distance measuring unit configured to measure a distance between the gesture-based apparatus and a user, a gesture recognition unit configured to recognize a gesture of the user, and a control unit configured to compare the measured distance with a predetermined distance and configured to control the gesture recognition unit based at least in part on the comparison result.

### BACKGROUND ART

A gesture user interface technology allows users to control various functions of an electronic device, such as, for example, a tablet computer, a television and a kiosk, without actually touching a screen and/or pushing a button of the device. However, when an electronic device supports both a gesture input function and other types of input functions such as a touch input function or a button input function, there may be a problem where the device erroneously recognizes as a gesture input a user action intended to operate the device by touching the screen or pushing the button.

### DISCLOSURE OF INVENTION

In an example, a method may include detecting, by a gesture-based apparatus, an object within a predetermined distance of the gesture-based apparatus, and responsive to detecting the object within the predetermined distance, disabling a gesture input function of the gesture-based apparatus.

In an example, a gesture-based apparatus may include a distance measuring unit configured to measure a distance between the gesture-based apparatus and a user, a gesture recognition unit configured to recognize a gesture of the user, and a control unit configured to compare the measured distance with a predetermined distance and configured to control the gesture recognition unit based at least in part on the comparison result.

In an example, a computer-readable storage medium may store computer-executable instructions that, in response to execution, cause a gesture-based apparatus having a gesture input function to perform operations, including detecting an object within a predetermined distance of the gesture-based apparatus, and responsive to detecting the object within the predetermined distance, disabling the gesture input function.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of an environment where a user operates a gesture-based apparatus from a distance;

FIG. 2 schematically shows an illustrative example of an environment where a user operates a gesture-based apparatus in close proximity to the apparatus;

FIG. 3 shows a schematic block diagram of an illustrative example of a gesture-based apparatus;

FIG. 4 shows an example flow diagram of a method for controlling a gesture-based apparatus;

FIG. 5 illustrates computer program products that can be utilized to provide a gesture-based user interface; and

FIG. 6 is a block diagram illustrating an example computing device that can be utilized to provide a gesture-based user interface,

all arranged in accordance with at least some embodiments described herein.

### MODE FOR THE INVENTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to a gesture-based user interface.

Briefly stated, technologies are generally described for providing an adaptive user interface. When a gesture-based apparatus also provides other input functions such as a touch input function or a button input function in addition to a gesture input function, there is a possibility that the gesture-based apparatus erroneously recognizes as a gesture input a user action which is not intended to operate the apparatus by gesturing. For example, although a user intends to touch a screen or push a button of the gesture-based apparatus, the apparatus may recognize the user's movement or action as a gesture input for the apparatus. In some examples, to avoid such misinterpretation of user intention, the gesture-based apparatus may measure a distance between the gesture-based apparatus and the user, and disable the gesture input function of the apparatus if the distance is shorter than a predetermined distance.

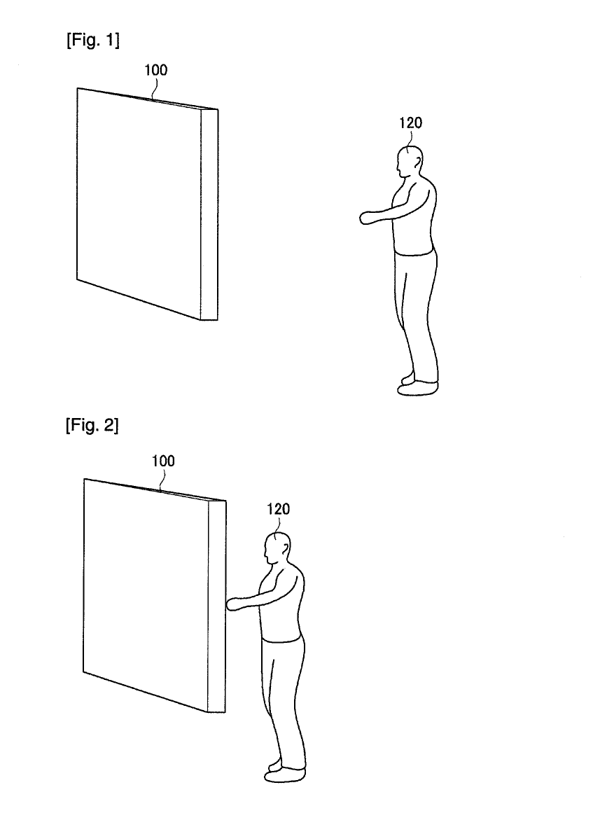

FIGS. 1 and 2 respectively show illustrative examples of environments where a user operates a gesture-based apparatus from a distance and in close proximity to the apparatus in accordance with at least some embodiments described herein. As depicted in FIG. 1, a gesture-based apparatus 100 providing a gesture input function may be operated or controlled based at least in part on a gesture of a user 120. User 120 may operate gesture-based apparatus 100 by moving his/her body parts. In some embodiments, gesture-based apparatus 100 may scan or read an action of user 120, and interpret the action as a gesture input. In some embodiments, gesture-based apparatus 100 may include an image capturing device such as a camera (not shown) configured to capture an image of user 120, and a display screen (not shown) configured to display any visual contents. By way of example, but not limitation, gesture-based apparatus 100 may include a tablet computer, a television, a kiosk, and any other device having gesture recognition function.

In some embodiments, in cases where gesture-based apparatus 100 provides other input functions such as, for example, a touch input function or a button input function in addition to the gesture recognition function, that is, gesture-based apparatus 100 is configured to receive physical indications (e.g., touch of a screen or push of a button) from user 120, gesture-based apparatus 100 may be operated by user 120 in close proximity thereto as depicted in FIG. 2. In such cases, gesture-based apparatus 100 may disable the gesture input function so as to avoid erroneous gesture recognition.

In some embodiments, gesture-based apparatus 100 may determine whether user 120 is within a predetermined distance of gesture-based apparatus 100. In some embodiments, if user 120 is within the predetermined distance, gesture-based apparatus 100 may disable a gesture input function thereof.

In some embodiments, gesture-based apparatus 100 may measure a distance between gesture-based apparatus 100 and user 120, and compare the measured distance with a predetermined distance. If the measured distance is shorter than the predetermined distance, gesture-based apparatus 100 may disable the gesture input function. Otherwise, gesture-based apparatus 100 may enable the gesture input function. In some embodiments, gesture-based apparatus 100 may optionally disable the other input functions such as the touch input function or the button input function thereof, if the measured distance is longer than the predetermined distance. In some embodiments, gesture-based apparatus 100 may present or inform user 120 of which one of the input functions is currently enabled. By way of example, but not limitation, gesture-based apparatus 100 may present information as to whether the gesture input function or the other input function (e.g., the touch input function or the button input function) is currently enabled. By way of example, but not limitation, gesture-based apparatus 100 may display on the display screen (not shown) information regarding the currently enabled input function. By way of example, but not limitation, gesture-based apparatus 100 may include light emitting diodes (LEDs), each of which corresponds to or is associated with each of the available input functions, and turn on the LED corresponding to the input function enabled currently.

In some embodiments, the predetermined distance may be based at least in part on statistical information on human arm length. By way of example, but not limitation, gesture-based apparatus 100 may be configured to disable the gesture input function if the measured distance is shorter than an average human arm length. The average human arm length may be between approximately 0.5 m and 0.7 m or approximately 20 in and 28 in.

In some embodiments, gesture-based apparatus 100 may determine or estimate the distance between gesture-based apparatus 100 and user 120 based at least in part on a face size of user 120 and/or a distance between two eyes, i.e., interocular distance of user 120. By way of example, but not limitation, gesture-based apparatus 100 may determine or estimate the distance between gesture-based apparatus 100 and user 120 using a face size and/or an interocular distance of user 120 in an image captured by the camera included in gesture-based apparatus 100. By way of example, but not limitation, gesture-based apparatus 100 may include a memory storing information on a relation between average human face size (in pixels) and person-to-camera distance (in meters or in inches) and/or information on a relation between average human interocular distance (in pixels) and person-to-camera distance (in meters or in inches). Table 1 below illustrates an example of the information on the relation between average human face size and person-to-camera distance and/or the relation between average human interocular distance and person-to-camera distance that may be stored in the memory of gesture-based apparatus 100. In some embodiments, the camera may capture the image of user 120, detect the face size or the interocular distance of user 120 in the image, and determine the distance between user 120 and the camera as the person-to-camera distance corresponding to the detected face size or interocular distance with reference to the information illustrated in Table 1.

TABLE 1

| Person-to-camera | | Interocular distance(in |
|---|---|---|
| distance(in inches) | Face size(in pixels) | pixels) |
| 32 | 58 × 58 | 34 |
| 30 | 65 × 65 | 36 |
| 28 | 68 × 68 | 38 |
| 24 | 78 × 78 | 43 |
| 22 | 85 × 85 | 47 |
| 20 | 90 × 90 | 50 |
| 18 | 100 × 100 | 55 |
| 15 | 115 × 115 | 65 |
| 12 | 145 × 145 | 80 |
| 10 | 168 × 168 | 93 |
| 8 | 190 × 190 | 108 |
| 7 | 213 × 213 | 129 |

In some embodiments, in cases where the camera included in gesture-based apparatus 100 is an autofocus camera, gesture-based apparatus 100 may determine or estimate the distance between gesture-based apparatus 100 and user 120 based at least in part on focusing information of the camera. By way of example, but not limitation, when the face of user 120 is focused by the camera, an autofocus ring encoder of the camera may provide information on the distance between the face of user 120 and the camera. Gesture-based apparatus 100 may determine or estimate the distance between gesture-based apparatus 100 and user 120 based at least in part on the information.

In some embodiments, gesture-based apparatus 100 may include a depth camera (not shown) configured to detect a distance between the depth camera and a head or a body of user 120. Gesture-based apparatus 100 may determine or estimate the distance between gesture-based apparatus 100 and user 120 based at least in part on the distance detected by the depth camera.

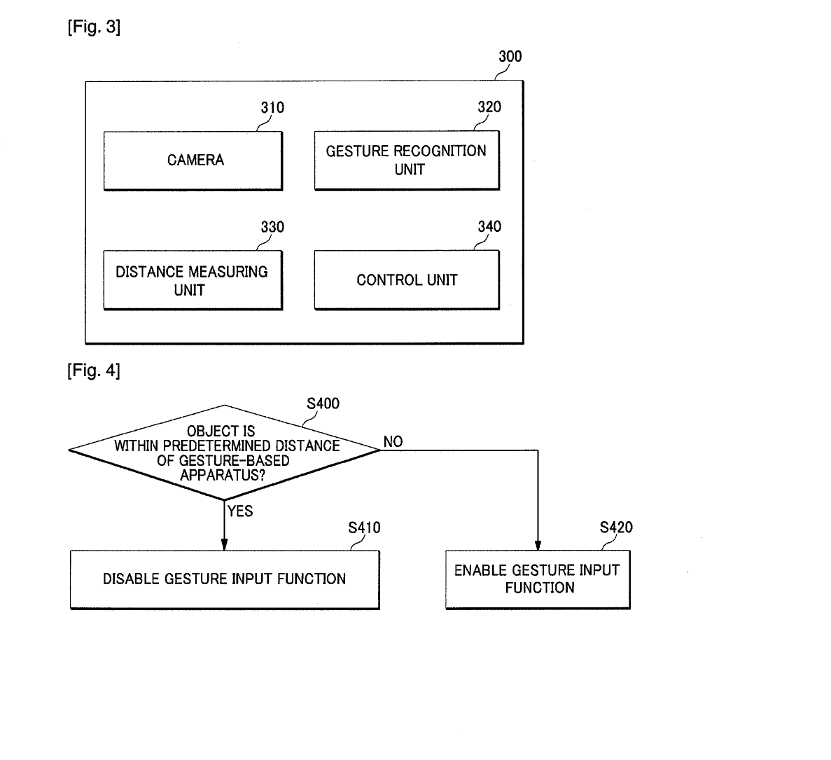

FIG. 3 shows a schematic block diagram of an illustrative example of a gesture-based apparatus in accordance with at least some embodiments described herein. As depicted, a gesture-based apparatus 300 may include a camera 310, a gesture recognition unit 320, a distance measuring unit 330 and a control unit 340. Although illustrated as discrete components, various components may be divided into additional components, combined into fewer components, or eliminated while being contemplated within the scope of the disclosed subject matter.

Camera 310 may be configured to capture an image of an object including a user of gesture-based apparatus 300. Camera 310 may also be configured to detect a movement of an object including the user of gesture-based apparatus 300.

In some embodiments, camera 310 may include an autofocus camera. In such cases, gesture-based apparatus 300 may determine or estimate a distance between gesture-based apparatus 300 and the user based at least in part on focusing information of camera 310. In some embodiments, camera 310 may include a depth camera configured to detect a distance between the user and the depth camera.

Gesture recognition unit 320 may be configured to recognize a gesture of the user of gesture-based apparatus 300. In some embodiments, gesture recognition unit 320 may recognize the gesture of the user based at least in part on the image captured by camera 310 and/or the movement detected by camera 310.

Distance measuring unit 330 may be configured to measure a distance between gesture-based apparatus 300 and an object including the user of gesture-based apparatus 300.

In some embodiments, distance measuring unit 330 may measure the distance based at least in part on the image captured by camera 310. Based at least in part on a relation between average human face size and person-to-camera distance and/or a relation between average human interocular distance and person-to-camera distance, distance measuring unit 330 may estimate the distance between camera 310 and the user, thereby estimating the distance between gesture-based apparatus 300 and the user. By way of example, but not limitation, gesture-based apparatus 300 may include or store in memory information on the relation between average human face size (in pixels) and person-to-camera distance (in meters or in inches) and/or the relation between average human interocular distance (in pixels) and person-to-camera distance (in meters or in inches). An example of the information on the relation between average human face size and person-to-camera distance and/or the relation between average human interocular distance and person-to-camera distance that may be included or stored in gesture-based apparatus 300 is illustrated above with reference to Table 1. Based thereon, gesture-based apparatus 300 may determine or estimate the distance between camera 310 and the user using the face size or interocular distance of the user in the image captured by camera 310.

In some embodiments, in cases where camera 310 is an autofocus camera, distance measuring unit 330 may measure the distance based at least in part on focusing information of camera 310. By way of example, but not limitation, when the face of the user is focused by camera 310, an autofocus ring encoder of camera 310 may provide information on the distance between the face of the user and camera 310. Based at least in part on such information, distance measuring unit 330 may estimate the distance between gesture-based apparatus 300 and the user.

In some embodiments, in cases where gesture-based apparatus 300 further includes a depth camera (not shown) configured to detect a distance between the depth camera and an object, distance measuring unit 330 may measure the distance between gesture-based apparatus 300 and the user based at least in part on the distance detected by the depth camera.

Control unit 340 may be configured to compare the distance measured or estimated by distance measuring unit 330 with a predetermined distance, and to control gesture recognition unit 320 based at least in part on the comparison result. In some embodiments, in cases where the distance measured or estimated by distance measuring unit 330 is shorter than the predetermined distance, control unit 340 may control gesture recognition unit 320 to be disabled. Otherwise, control unit 340 may control gesture recognition unit 320 to be enabled.

In some embodiments, the predetermined distance may be based at least in part on statistical information on human arm length. By way of example, but not limitation, control unit 340 may control gesture recognition unit 320 to be disabled if the distance measured or estimated by distance measuring unit 330 is shorter than an average human arm length, which may be, for example, between approximately 0.5 m and 0.7 m or approximately 20 in and 28 in.

In some embodiments, gesture-based apparatus 300 may further include other input devices. By way of example, but not limitation, gesture-based apparatus 300 may include a touch screen having a touch input function. In such cases, control unit 340 may disable the touch input function if the distance is longer than the predetermined distance.

In some embodiments, gesture-based apparatus 300 may further include an informing unit (not shown) configured to present or inform the user of which one of the input functions of gesture-based apparatus 300 is currently enabled. By way of example, but not limitation, in cases where gesture-based apparatus 300 includes the touch screen having the touch input function and where control unit 340 is configured to disable the touch input function if the distance is longer than the predetermined distance, the informing unit may present information indicative of whether the gesture input function or the touch input function is currently enabled.

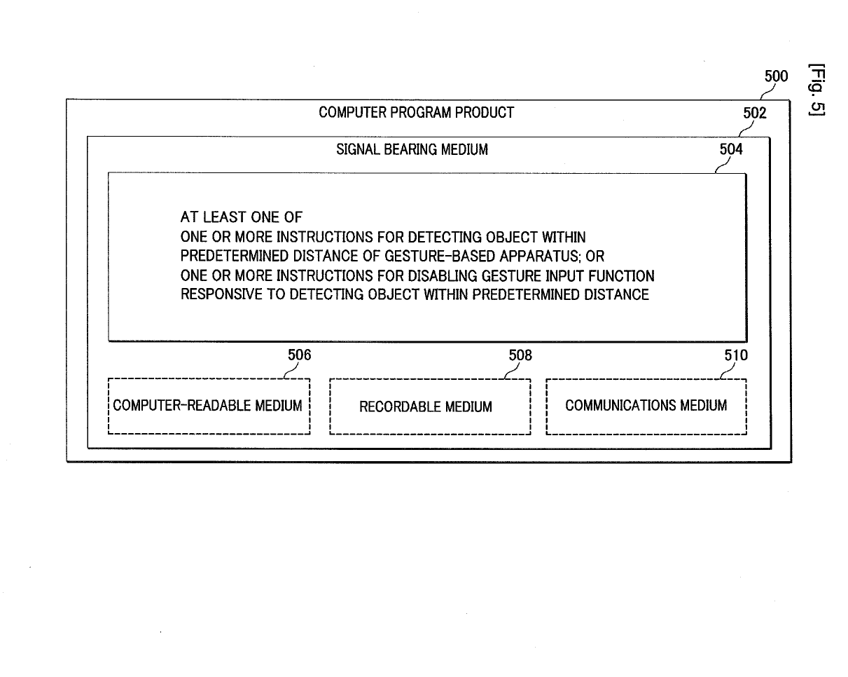

FIG. 4 shows an example flow diagram of a method for controlling a gesture-based apparatus in accordance with at least some embodiments described herein. The method in FIG. 4 could be implemented using gesture-based apparatus 300 discussed above. An example process may include one or more operations, actions, or functions as illustrated by one or more blocks S400, S410 and/or S420. Although illustrated as discrete blocks, various blocks may be divided into additional blocks, combined into fewer blocks, or eliminated, and is not limited with these respects. Processing may begin at block S400.

At block S400, a gesture-based apparatus having a gesture input function may detect an object within a predetermined distance of the gesture-based apparatus. In some embodiments, the gesture-based apparatus may measure a distance between the gesture-based apparatus and the object, and compare the measured distance with the predetermined distance. In some embodiments, the object may be a user of the gesture-based apparatus.

In some embodiments, the gesture-based apparatus may determine or estimate the distance based at least in part on an image of the object captured by a camera included in or attached to the gesture-based apparatus. In some embodiments, the gesture-based apparatus may determine or estimate the distance based at least in part on focusing information of the camera. In some embodiments, the gesture-based apparatus may measure the distance using a depth camera.

In some embodiments, the predetermined distance may be based at least in part on statistical information on human arm length, e.g., an average human arm length. The average human arm length may be between approximately 0.5 m and 0.7 m or approximately 20 in and 28 in.

If the object is within the predetermined distance, the gesture-based apparatus may disable the gesture input function (block S410). Otherwise, i.e., if the object is beyond the predetermined distance, the gesture-based apparatus may enable the gesture input function (block S420).

Optionally, the gesture-based apparatus may disable other input functions of the gesture-based apparatus, such as, for example, a touch input function, if the distance is longer than the predetermined distance. In such cases, the gesture-based apparatus may present or inform the user of which one of the input functions of the gesture-based apparatus is currently enabled.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

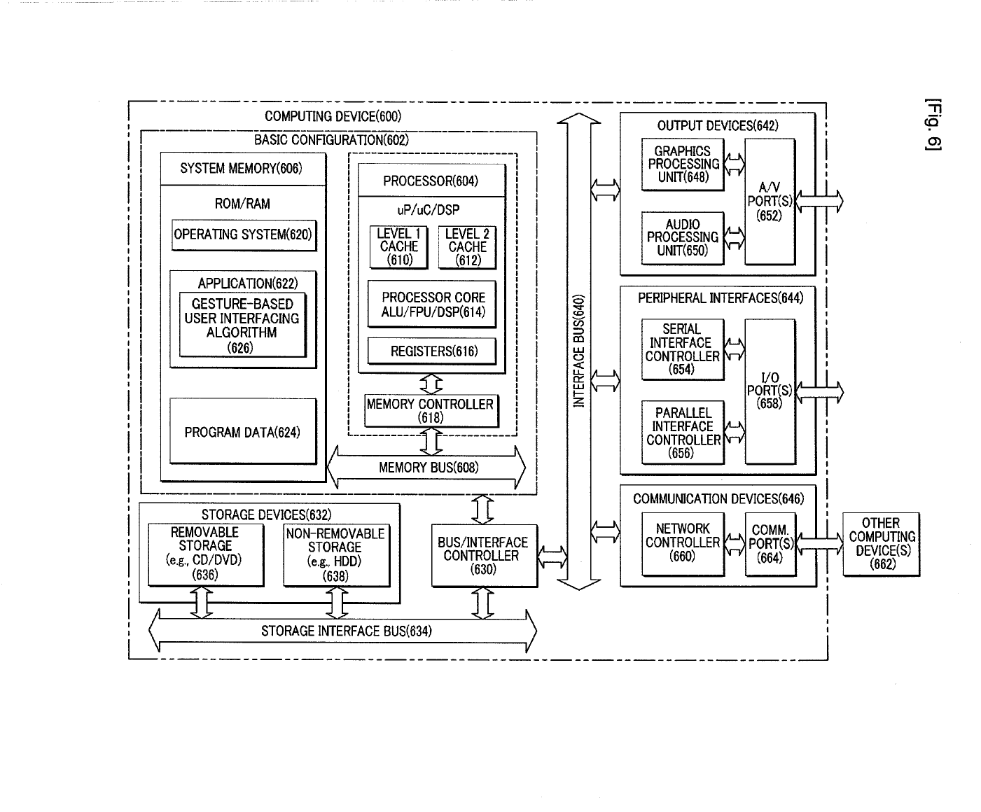

FIG. 5 illustrates computer program products 500 that can be utilized to provide a gesture-based user interface in accordance with at least some embodiments described herein. Program product 500 may include a signal bearing medium 502. Signal bearing medium 502 may include one or more instructions 504 that, when executed by, for example, a processor, may provide the functionality described above with respect to FIGS. 1-4. By way of example, instructions 504 may include: one or more instructions for detecting an object within a predetermined distance of the gesture-based apparatus; one or more instructions for disabling the gesture input function responsive to detecting the object within the predetermined distance. Thus, for example, referring to the system of FIG. 3, gesture-based apparatus 300 may undertake one or more of the blocks shown in FIG. 4 in response to instructions 504.

In some implementations, signal bearing medium 502 may encompass a computer-readable medium 506, such as, but not limited to, a hard disk drive, a Compact Disc (CD), a Digital Video Disk (DVD), a digital tape, memory, etc. In some implementations, signal bearing medium 502 may encompass a recordable medium 508, such as, but not limited to, memory, read/write (R/W) CDs, R/W DVDs, etc. In some implementations, signal bearing medium 502 may encompass a communications medium 510, such as, but not limited to, a digital and/or an analog communication medium (e.g., a fiber optic cable, a waveguide, a wired communications link, a wireless communication link, etc.). Thus, for example, program product 500 may be conveyed to one or more modules of gesture-based apparatus 300 by an RF signal bearing medium 502, where the signal bearing medium 502 is conveyed by a wireless communications medium 510 (e.g., a wireless communications medium conforming with the IEEE 802.11 standard).

FIG. 6 is a block diagram illustrating an example computing device 600 that can be utilized to provide a gesture-based user interface in accordance with at least some embodiments described herein. In a very basic configuration 602, computing device 600 typically includes one or more processors 604 and a system memory 606. A memory bus 608 may be used for communicating between processor 604 and system memory 606.

Depending on the desired configuration, processor 604 may include control unit 340 as previously described and may typically be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624.

Application 622 may include a gesture-based user interfacing algorithm 626 that is arranged to perform the functions as described herein including those described previously with respect to FIGS. 1-5. Program data 624 may include any data that may be useful for providing a gesture-based user interface as is described herein. In some embodiments, application 622 may be arranged to operate with program data 624 on operating system 620 such that a gesture-based user interface may be provided. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method comprising:
detecting, by a gesture-based apparatus, an object within a predetermined distance of the gesture-based apparatus; and
responsive to detecting the object within the predetermined distance, disabling a gesture input function of the gesture-based apparatus.

2. The method of claim 1, wherein the detecting includes measuring a distance between the gesture-based apparatus and the object.

3. The method of claim 1, further comprising:
disabling a touch input function of the gesture-based apparatus if the object is beyond the predetermined distance.

4. The method of claim 3, further comprising:
informing as to which one of the input functions of the gesture-based apparatus is currently enabled.

5. The method of claim 1, wherein the predetermined distance is based at least in part on statistical information on human arm length.

6. The method of claim 1, wherein the object is a user of the gesture-based apparatus.

7. The method of claim 6, wherein the detecting includes measuring a distance between the gesture-based apparatus and the user based at least in part on a face size of the user.

8. The method of claim 6, wherein the detecting includes measuring a distance between the gesture-based apparatus and the user based at least in part on a face size of the user in an image captured by a camera included with the gesture-based apparatus.

9. The method of claim 6, wherein the detecting includes measuring a distance between the gesture-based apparatus and the user based at least in part on a distance between two eyes of the user.

10. The method of claim 6, wherein the detecting includes measuring a distance between the gesture-based apparatus and the user using a distance between two eyes of the user in an image captured by a camera.

11. The method of claim 6, wherein the detecting includes measuring a distance between the gesture-based apparatus and the user based at least in part on focusing information of a camera.

12. The method of claim 6, wherein the detecting includes measuring a distance between the gesture-based apparatus and the user using a depth camera.

13. The method of claim 12, wherein the detecting includes measuring a distance between a head of the user and the depth camera.

14. The method of claim 12, wherein the detecting includes measuring a distance between a body of the user and the depth camera.

15. A gesture-based apparatus, comprising:
a distance measuring unit configured to measure a distance between the gesture-based apparatus and a user;
a gesture recognition unit configured to recognize a gesture of the user; and
a control unit configured to compare the measured distance with a predetermined distance and configured to control the gesture recognition unit based at least in part on the comparison result.

16. The gesture-based apparatus of claim 15, wherein the control unit is further configured to disable the gesture recognition unit if the distance is shorter than the predetermined distance.

17. The gesture-based apparatus of claim 15, further comprising:
a camera configured to capture an image of the user.

18. The gesture-based apparatus of claim 17, wherein the distance measuring unit is further configured to measure the distance based at least in part on an image captured by the camera.

19. The gesture-based apparatus of claim 15, further comprising:
a depth camera configured to detect a distance between the user and the depth camera.

20. The gesture-based apparatus of claim 15, further comprising:
a touch screen having a touch input function,
wherein the control unit is further configured to disable the touch input function if the distance is longer than the predetermined distance.

21. The gesture-based apparatus of claim 20, further comprising:
an informing unit configured to inform as to which one of the input functions of the gesture-based apparatus is currently enabled.

22. The gesture-based apparatus of claim 20, wherein the distance measuring unit is further configured to measure a distance between the touch screen and the user.

23. The gesture-based apparatus of claim 15, wherein the predetermined distance is based at least in part on statistical information on human arm length.

24. A computer-readable storage medium having stored thereon computer-executable instructions that, in response to execution, cause a gesture-based apparatus having a gesture input function to perform operations, comprising:
detecting an object within a predetermined distance of the gesture-based apparatus; and
responsive to detecting the object within the predetermined distance, disabling the gesture input function.

25. The computer-readable storage medium of claim 24, wherein the detecting includes measuring a distance between the gesture-based apparatus and the object and comparing the distance with the predetermined distance.

26. The computer-readable storage medium of claim 24, wherein the detecting includes estimating a distance between the gesture-based apparatus and the object based at least in part on a captured image of the object.

27. The computer-readable storage medium of claim 24, the operations further comprising:
disabling a touch input function of the gesture-based apparatus if the object is beyond the predetermined distance.

28. The computer-readable storage medium of claim 24, wherein the predetermined distance is based at least in part on statistical information on human arm length.
